(19) United States
(12) Patent Application Publication
(10) Pub. No.: US 2019/0012629 A1
(43) Pub. Date: Jan. 10, 2019

(54) TEAM PERFORMANCE SUPERVISOR

(71) Applicant: Findo, Inc., Menlo Park, CA (US)

(72) Inventor: David YAN, Portola Valley, CA (US)

(21) Appl. No.: 16/030,598

(22) Filed: Jul. 9, 2018

Related U.S. Application Data
(60) Provisional application No. 62/530,798, filed on Jul. 10, 2017.
(60) Provisional application No. 62/552,625, filed on Aug. 31, 2017.

(51) Int. Cl. G06Q 10/06; G06Q 10/10; G06N 3/08

(52) U.S. Cl. CPC G06Q 10/06398; G06N 3/08; G06Q 10/107

(57) ABSTRACT

An example method of employee performance evaluation comprises: processing a plurality of documents which record communications of a person to identify a task assigned to the person; identifying a subset of the plurality of documents, wherein the subset of documents is associated with the task; analyzing the subset of documents to identify a completion status of the task; and determining a value of a performance metric associated with the person, wherein the value of the performance metric reflects the completion status of the task.

### REFERENCE TO RELATED APPLICATIONS

This application claims the benefit of U.S. Provisional Application No. 62/530,798, filed on Jul. 10, 2017, and of U.S. Provisional Application No. 62/552,625, filed on Aug. 31, 2017. The entire contents of both above-referenced provisional applications are hereby incorporated by reference herein.

### TECHNICAL FIELD

The present disclosure is generally related to computer systems, and is more specifically related to systems and methods of performance evaluation based on processing structured communications.

### BACKGROUND

Employee performance evaluation is an integral element of human resource management processes in many organizations. Various common performance evaluation methods rely heavily on human-generated information, such as evaluation questionnaires, interview summaries, unstructured or weakly-structured feedback generated by the employee's supervisors, peers, and subordinates, etc.

### SUMMARY

An example method of employee performance evaluation comprises: processing a plurality of documents which record communications of a person to identify a task assigned to the person; identifying a subset of the plurality of documents, wherein the subset of documents is associated with the task; analyzing the subset of documents to identify a completion status of the task; and determining a value of a performance metric associated with the person, wherein the value of the performance metric reflects the completion status of the task.

Another example method of employee performance evaluation comprises: processing, by a computer system, a plurality of documents which record communications of a person to identify a task assigned to the person; identifying a subset of the plurality of documents, wherein the subset of documents is associated with the task; analyzing the subset of documents to identify a level of sentiments associated with the task; and determining a value of a performance metric associated with the person, wherein the value of the performance metric reflects the level of sentiments.

Another example method of employee performance evaluation comprises: processing a plurality of documents which record communications of a person to identify a task assigned to the person; applying, to the plurality of documents, a trainable classifier to identify a completion status of the task; and determining a value of a performance metric associated with the person, wherein the value of the performance metric reflects the completion status of the task.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 schematically illustrates an example performance evaluation workflow implemented in accordance with one or more aspects of the present disclosure;

FIG. 2 schematically illustrates a high-level network diagram of a distributed computer systems implemented by a corporate network in which the systems and methods of the present disclosure may be implemented;

FIG. 3 depicts a flow diagram of an example method of performance evaluation based on processing structured communications, in accordance with one or more aspects of the present disclosure; and

FIG. 4 schematically illustrates a component diagram of an example computer system which may perform the methods described herein.

### DETAILED DESCRIPTION

Described herein are systems and methods for performance evaluation based on processing structured communications (e.g., electronic mail messages).

Employee performance evaluation is an integral element of human resource management processes in many organizations. Various common performance evaluation methods rely heavily on human-generated information, such as evaluation questionnaires, interview summaries, unstructured or weakly-structured feedback generated by the employee's supervisors, peers, and subordinates, etc. Apart from being highly subjective, such information requires considerable human effort to generate.

The present disclosure addresses the above-noted and other deficiencies of common performance evaluation methods, by providing methods of performance evaluation based on processing structured communications (such as electronic mail messages, instant messages, and/or voicemail transcriptions). The systems and methods of the present disclosure process a set of employee's electronic mail messages in order to extract information on various tasks assigned to and completed by the employee whose performance is being evaluated.

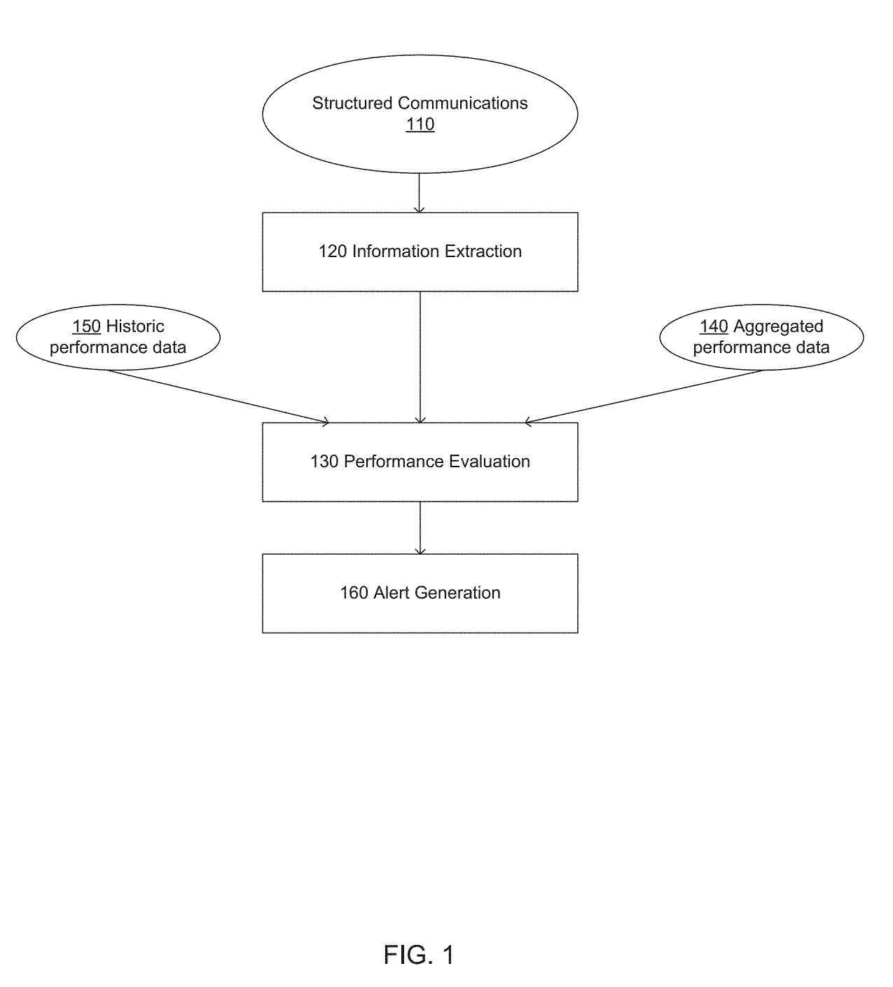

FIG. 1 schematically illustrates an example performance evaluation workflow implemented in accordance with one or more aspects of the present disclosure. The information extraction engine 120 may process a set of structured communications 110 (e.g., electronic mail messages, instant messages, and/or voicemail transcriptions stored by a corporate messaging server) to identify one or more tasks assigned to an employee whose performance is being evaluated. For every task, the information extraction engine 120 may determine its current completion status, the time taken to complete the task, the task category, importance, and complexity, the level of sentiments associated with the task progress and results, and/or various other attributes of the task. The extracted information may be fed to the performance evaluation engine 130, which may compute values of a set of performance evaluation metrics (e.g., the rate of task completion for a given task category, importance, and/or complexity level, the task completion quality based on the detected level of sentiments, the effectiveness of employee's participation in collective work efforts based on the detected rate of responding to communications and associated level of sentiments, etc.). The performance evaluation engine may then compare the computed employee performance metrics to various aggregate performance metrics 140 (e.g., reflecting the average performance demonstrated by the employee's organizational unit and/or by the whole organization) and/or historic metrics 150 (e.g., parameters reflecting the performance of the same employee over one or more periods preceding the current periods). Should a significant deviation of the employee performance parameters from aggregate performance metrics 140 and/or historic performance metrics 150 be detected, the performance evaluation engine 130 may generate alerts 160 (e.g., in the form of electronic mail messages or instant messages) to the employee's supervisors, thus prompting them to reward the employee or take appropriate corrective actions, as described in more detail herein below.

The systems and methods described herein may be implemented by hardware (e.g., general purpose and/or specialized processing devices, and/or other devices and associated circuitry), software (e.g., instructions executable by a processing device), or a combination thereof. Various aspects of the methods and systems are described herein by way of examples, rather than by way of limitation. In particular, certain specific examples are referenced and described herein for illustrative purposes only and do not limit the scope of the present disclosure.

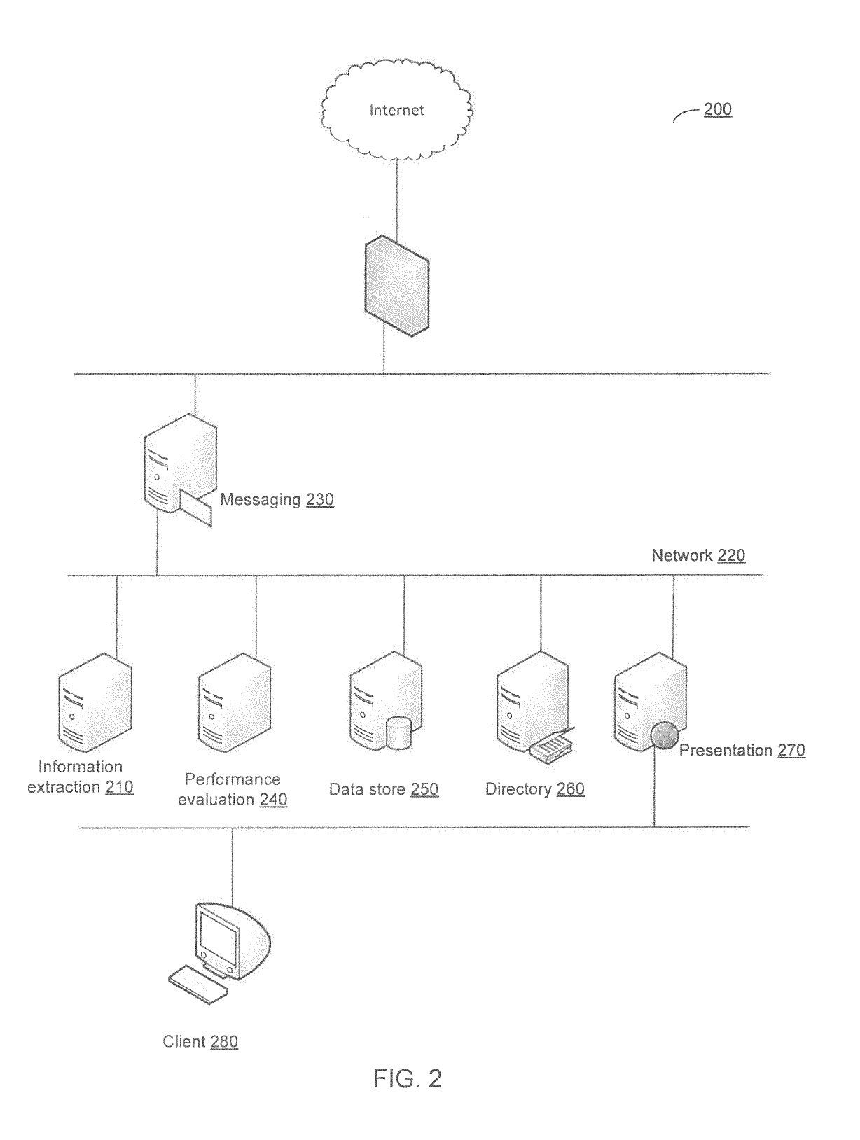

FIG. 2 schematically illustrates a high-level network diagram of a distributed computer systems implemented by a corporate network in which the systems and methods of the present disclosure may be implemented. As schematically illustrated by FIG. 2, the distributed computer system may comprise the information extraction server 210 which may communicate, over one or more network segments 220, with the corporate messaging server (e.g., electronic mail and/or instant messaging server) 230, performance evaluation server 240, data store 250, directory server 260, presentation server 270, one or more client computers 280, and various other computers connected to the corporate network 200.

The information extraction server 210 may process a set of structured communications (e.g., electronic mail messages, instant messages, and/or voicemail transcriptions stored by a corporate messaging server) to identify one or more tasks assigned to an employee whose performance is being evaluated and to further identify one or more attributes of each detected task. The information extraction server 210 may perform the information extraction by applying a combination of statistical (e.g., trainable classifiers) and rule-based methods.

An example statistical method may use a Generalized Left-to-right parser producing Rightmost-derivation (GLR parser). On the front-end, a GLR parser converts an input text into parse tables, which allow multiple state transitions (given a state and an input token). When a conflicting transition is encountered, the parse stack is forked into two or more parallel parse stacks, such that the state corresponding to each possible transition is located at the top of the respective stack. Then, the next input token is read and used to determine the next transitions for each of the top states, at which stage further forking may occur. If any given top state and input token do not result in at least one transition, the corresponding path “path” through the parse tables is deemed to be invalid and is discarded. The parser thus produces a parse tree which describes syntactic relationships between various information objects referenced by tokens of the input text.

In another illustrative example, the information extraction server 210 may employ one or more trainable classifiers, such that each classifier processes the input text to yield the degree of association of an information object referenced by an input text token with a specified ontology concept. Each classifier may implement various methods ranging from naïve Bayes to differential evolution, support vector machines, random forests, neural networks, gradient boosting, etc.

In another illustrative example, the information extraction server 210 may employ one or more bi-directional recurrent neural networks (RNN). A recurrent neural network is a computational model which is based on a multi-staged algorithm applying a set of pre-defined functional transformations to a plurality of inputs and then utilizing the transformed data and the network stored internal state for processing subsequent inputs. In certain implementations, an RNN employed by the information extraction server 210 may utilize long short-term memory (LSTM) units. The term “long short-term” refers to a short-term memory model which can persist for a long period of time. An LSTM unit includes a cell, an input gate, an output gate, and a forget gate. The cell is responsible for storing values over arbitrary time intervals. Each of the three gates can be viewed as an artificial neuron which computes an activation of a weighted sum, thus regulating the flow of values through the connections of the LSTM. Thus, an LSTM-based neural network may be utilized to classify, process, and predict time series having time lags of unknown duration between important events.

In another illustrative example, the information extraction server 210 may employ rule-based information extraction methods, which may apply a set of production rules to a graph representing syntactic and/or semantic structure of the input text. The production rules may interpret the graph and yield definitions of information objects referenced by tokens of the input text and identify various relationships between the extracted information objects. In an illustrative example, the left-hand side of a rule may include a set of logical expressions defined on one or more templates applied to the graph representing the input text. The template may reference one or more lexical structure elements (e.g., a certain grammeme or semanteme etc.), syntactic structure elements (e.g., a surface or deep slot) and/or semantic structure elements (e.g., an ontology concept). Matching the template defined by the left-hand side of the rule to at least a part of the graph representing the input text triggers the right-hand side of the rule, which associates one or more attributes (e.g., an ontology concept) with an information object referenced by a token of the input text.

As noted herein above, the information extraction server 210 may process a set of structured communications (e.g., electronic mail messages, instant messages, and/or voicemail transcriptions stored by a corporate messaging server) to identify one or more tasks assigned to an employee whose performance is being evaluated. In order to identify the tasks, the information extraction server 210 may process both payload (text) and metadata (e.g., the header fields identifying the sender and the addressee of an electronic mail message, the message timestamps, the message priority or importance indicator, etc.). Each input document (e.g., an electronic mail message, an instant message, or a voicemail transcript) may be represented by a vector of features, which are derived from the terms extracted from the document body and/or document metadata. Accordingly, a named entity extraction pipeline may be employed to extract the named entities from To:, Cc:, and/or From: fields of the set of structured communications. In certain implementations, another named entity extraction pipeline may be employed to extract the named entities from the body and/or subject line of the electronic messages. In certain implementations, yet another extraction pipeline may be employed for extracting document timestamps, priority and/or importance indicators, and/or various other metadata. A separate extraction pipelines may analyze the message bodies. Each of the extraction pipelines may utilize the above described trainable classifiers, production rules, neural networks, statistical methods and/or their various combinations.

In an illustrative example, if a task assignment template specified by a production rule matches a graph representing an input document (e.g., an electronic mail message), a task is presumed to be assigned by the message sender to the message addressee. In certain implementations, the information extraction server 210 may further retrieve the organizational structure data from the directory server 260, and may only determine that a task has been assigned if the position of the presumed task initiator (i.e., the message sender) has a management authority over the employee to whom the task has been presumably assigned (i.e., the message addressee). In an illustrative example, the information extraction server 210 may determine that a task described by the body of a message has been assigned to an employee identified by the message metadata if a route satisfying one or more conditions is identified in the graph representing the organizational structure. Evaluating such conditions may include ascertaining that the hierarchical level of the employee to whom the task has been presumably assigned exceeds the hierarchical level of the presumed task initiator (assuming that the levels are sequentially numbered starting from the root vertex of the graph). The hierarchical levels may be retrieved from the directory server 260. In various alternative implementations, the task assignment may be detected by applying various combinations of statistical methods, trainable classifiers, rule sets and/or neural networks.

In certain implementations, the information extraction server 210 may, for every task, identify a subset of input documents (e.g., a logical thread of electronic mail messages) associated with the task. In an illustrative example, the logical thread may be identified based on the subject filed, the sender and addressee field, the message timestamps, and/or their various combinations. The information extraction server 210 may further determine the current completion status of the task, the time taken to complete the task, the task category, importance, and complexity, the level of sentiments expressed by the task initiator with respect to the task progress and results, whether the task has been completed by the due date which has been specified by the task initiator, and/or various other attributes of the task.

In certain implementations, the completion status may be represented by one of “assigned,” “in progress,” and “completed.” An assigned task may be presumed to transition to the “in progress” status upon the message in which the task assignment is detected has been read and/or replied by the employee. In an illustrative example, if a task completion template specified by a production rule matches a graph representing an input document (e.g., an electronic mail message), the task is presumed to be “completed.” In various alternative implementations, the task completion may be detected by applying various combinations of statistical methods, trainable classifiers, rule sets and/or neural networks.

In certain implementations, the task category may describe the functional nature of the task (e.g., “attending a planning session,” “gathering functional requirements,” “generating design,” “generating functional specifications,” etc.). In an illustrative example, the task category may be determined by a trainable classifier processing the bodies of one or more electronic mail messages of the thread associated with the task. In various alternative implementations, the task completion may be detected by applying various combinations of statistical methods, trainable classifiers, rule sets and/or neural networks.

The task importance may be represented by a numeric value reflecting a relative importance of the task on a pre-defined scale. In an illustrative example, the task importance may be determined by a trainable classifier processing the bodies of one or more electronic mail messages of the thread associated with the task. In various alternative implementations, the task importance may be detected by applying various combinations of statistical methods, trainable classifiers, rule sets and/or neural networks. In certain implementations, if the task importance is not expressly or implicitly specified by the electronic mail messages of the thread associated with the task, the information extraction server 210 may assign the task importance based on the hierarchical level of the task initiator within the organization, the frequency of communications between the employee and the task initiator, one or more pre-defined rules, and/or various combinations of the above-references criteria.

The task complexity may be represented by a numeric value reflecting an estimated level of effort or time which is necessary to complete the task. In an illustrative example, the task complexity may be determined by a trainable classifier processing the bodies of one or more electronic mail messages of the thread associated with the task. In various alternative implementations, the task complexity may be detected by applying various combinations of statistical methods, trainable classifiers, rule sets and/or neural networks.

The level of sentiments may reflect the sentiments of the task initiator and/or other concerned parties with respect to the progress, completion status, and/or quality of the work product associated with the task. In an illustrative example, the level of sentiments may be represented by a value indicating a “positive,” “neutral,” or “negative” sentiment; in another illustrative example, the level of sentiments may be represented by a numeric value on a pre-defined scale. In an illustrative example, the level of sentiment may be determined by a trainable classifier processing the bodies of one or more electronic mail messages of the thread associated with the task. In various alternative implementations, the level of sentiment may be detected by applying various combinations of statistical methods, trainable classifiers, rule sets and/or neural networks.

The extracted information may be fed to the performance evaluation server 240, which may produce the values one or more performance evaluation metrics characterizing the employee performance. In an illustrative example, the performance evaluation server 240 may compute the number of tasks of a given category, importance, and/or complexity level completed by a given employee within a specified period of time. In certain implementations, the performance evaluation server 240 may further compute the ratio of the number of tasks of a given category, importance, and/or complexity level which have been completed by the originally set due date to the total number of tasks completed by the employee. In another illustrative example, the performance evaluation server 240 may compute an aggregate (e.g., average, median, minimal, or maximal) level of sentiments which has been expressed by the task initiators and/or other concerned parties with respect to the employee performance within the specified period of time. In another illustrative example, the performance evaluation server 240 may compute the ratio of the number of tasks associated with a given (e.g., positive, neutral, or negative) level of sentiments expressed by the task initiator and/or other concerned parties to the total number of tasks completed by the employee. In another illustrative example, the performance evaluation server 240 may compute, for a given category, importance, and/or complexity level of tasks, an aggregate time period between task assignment and task completion by the employee. In another illustrative example, the performance evaluation server 240 may compute an aggregate time period between receiving an incoming communication and responding to the incoming communication by the employee. In another illustrative example, the performance evaluation server 240 may compute the total number of incoming communications to which the employee has responded within the specified period of time.

The performance evaluation server 240 may, for each employee, produce a vector of performance evaluation metric values, including the above-described and/or other performance indicators characterizing the performance of the employee within the specified period of time. In certain implementations, the performance evaluation server 240 may further produce, for each employee, a value of a synthetic performance evaluation metric, which may be produced by applying a pre-defined transformation (e.g., a weighted sum) to the above-described and/or other performance indicators characterizing the performance of the employee within the specified period of time.

In certain implementations, the performance evaluation server 240 may assign, to the employee whose performance being evaluated, a category characterizing the overall performance level of the employee in comparison with other employees within the organization and/or organizational unit. Examples of such categories include: winners (e.g., a pre-defined share of the employee population who have demonstrated the highest performance metric values and the highest level of sentiments), rising stars, best performers (e.g., a pre-defined share of the employee population who have demonstrated the highest performance metric values), worst performers (e.g., a pre-defined share of the employee population who have demonstrated the lowest performance metric values), the least engaged (e.g., employees who have demonstrated the worst communication response times), the most engaged (e.g., employees who have demonstrated the best communication response times), the fastest (e.g., employees who have demonstrated the best task completion times), the slowest (e.g., employees who have demonstrated the worst task completion times), etc.

Upon computing the performance evaluation metric values, the performance evaluation server 240 may compare the computed metric values with various aggregate metric values (e.g., aggregate performance metric of the organizational unit to which the employee is assigned). Additionally or alternatively, the performance evaluation server 240 may compare the computed metric values with various historic metric values characterizing the performance of the same employee within one or more periods of time preceding the current period of time. Responsive to determining a significant deviation of the computed performance evaluation metric values from the stored aggregate metric values and/or historic metric values, the performance evaluation server may generate an alert (e.g., an electronic mail message and/or instance message) to a supervisor of the employee whose performance is being evaluated, thus prompting the supervisor to reward the employee or take appropriate corrective actions.

The computed performance metric values may be fed to the presentation server 270, which may generate various reports to be presented via a graphical user interface to one or more users of client computers 280.

It should be noted that the functional designations of the servers shown in FIG. 2 are for illustrative purposes only; in various alternative implementations, one or more functional components may be collocated on a single physical server and/or a single functional component may be implemented by two or more physical servers. Furthermore, various network infrastructure components, such as firewalls, load balancers, network switches, etc., may be omitted from FIG. 2 for clarity and conciseness. Computer systems, servers, clients, appliances, and network segments are shown in FIG. 2 for illustrative purposes only and do not in any way limit the scope of the present disclosure. Various other computer systems, servers, clients, infrastructure components, appliances, and/or methods of their interconnection may be compatible with the methods and systems described herein

Thus, the systems and methods described herein may be utilized for evaluating individual employee performance and for comparing aggregate performance levels demonstrated by different organizational units within a single organization, in order to identify best and worst individual performers and teams and/or manage the workload assignment to individual performers and teams.

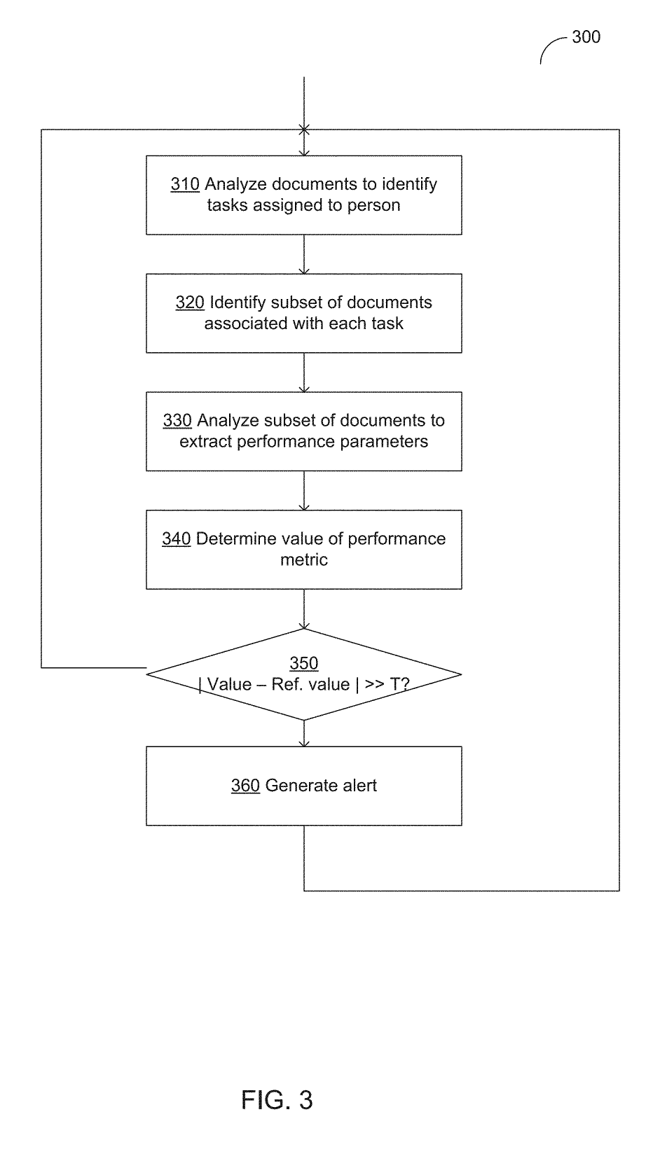

FIG. 3 depicts a flow diagram of an example method 300 of performance evaluation based on processing structured communications, in accordance with one or more aspects of the present disclosure. Method 300 and/or each of its individual functions, routines, subroutines, or operations may be performed by one or more processors of the computer system (e.g., the information extraction server 210 and/or performance evaluation server 240 of FIG. 2) implementing the method. In certain implementations, method 300 may be performed by a single processing thread. Alternatively, method 300 may be performed by two or more processing threads, each thread executing one or more individual functions, routines, subroutines, or operations of the method. In an illustrative example, the processing threads implementing method 300 may be synchronized (e.g., using semaphores, critical sections, and/or other thread synchronization mechanisms). Alternatively, the processing threads implementing method 300 may be executed asynchronously with respect to each other.

At block 310, the computer system implementing the method may process a plurality of documents which record communications of a person to identify one or more tasks assigned to the person. In various illustrative examples, the plurality of documents may include electronic mail messages, instant messages, and/or voicemail transcriptions, as described in more detail herein above.

At block 320, the computer system may identify a subset of documents associated with each of the identified tasks. In an illustrative example, the subset of documents may be represented by a logical thread of electronic mail messages, which may be identified based on the subject filed, the sender and addressee field, the message timestamps, and/or their various combinations, as described in more detail herein above.

At block 330, the computer system may analyze the subset of documents to extract various performance parameters characterizing performance of the person. In various illustrative examples, the performance parameters may include: the completion status of each task; the level of sentiments associated each task; the number of tasks of a given category, importance, and/or complexity level completed by the person within a specified period of time; the ratio of the number of tasks of a given category, importance, and/or complexity level which have been completed by the originally set due date to the total number of tasks completed by the person; the ratio of the number of tasks associated with a given (e.g., positive, neutral, or negative) level of sentiments expressed by the task initiator and/or other concerned parties to the total number of tasks completed by the person; an aggregate time period between task assignment and task completion by the person for a given category, importance, and/or complexity level of tasks; an aggregate time period between receiving an incoming communication and responding to the incoming communication by the person; and/or the total number of incoming communications to which the person has responded within the specified period of time, as described in more detail herein above.

At block 340, the computer system may determine a value of a performance metric associated with the person. The performance metric value may reflect the extracted performance parameters characterizing the performance of the person within the specified period of time. In an illustrative example, the performance metric may be represented by a vector of the above-described performance evaluation metric values. In another illustrative example, a synthetic performance evaluation metric may be produced by applying a pre-defined transformation (e.g., a weighted sum) to the above-described performance evaluation metric values, as described in more detail herein above.

Responsive to determining, at block 350, that the difference between the computed value of the performance metric and a reference performance metric value exceeds a pre-defined threshold, the computer system may, at block 360, generate an alert which references the value of the performance metric. In various illustrative examples, the reference performance metric value may be represented by an aggregate value of the performance metric associated with the organizational unit of the person or a historic value of the performance metric characterizing performance of the person in one or more time periods preceding the current time periods. The alert may be represented by an electronic mail message and/or instant message addresses to a supervisor of the person whose performance is being evaluated, as described in more detail herein above.

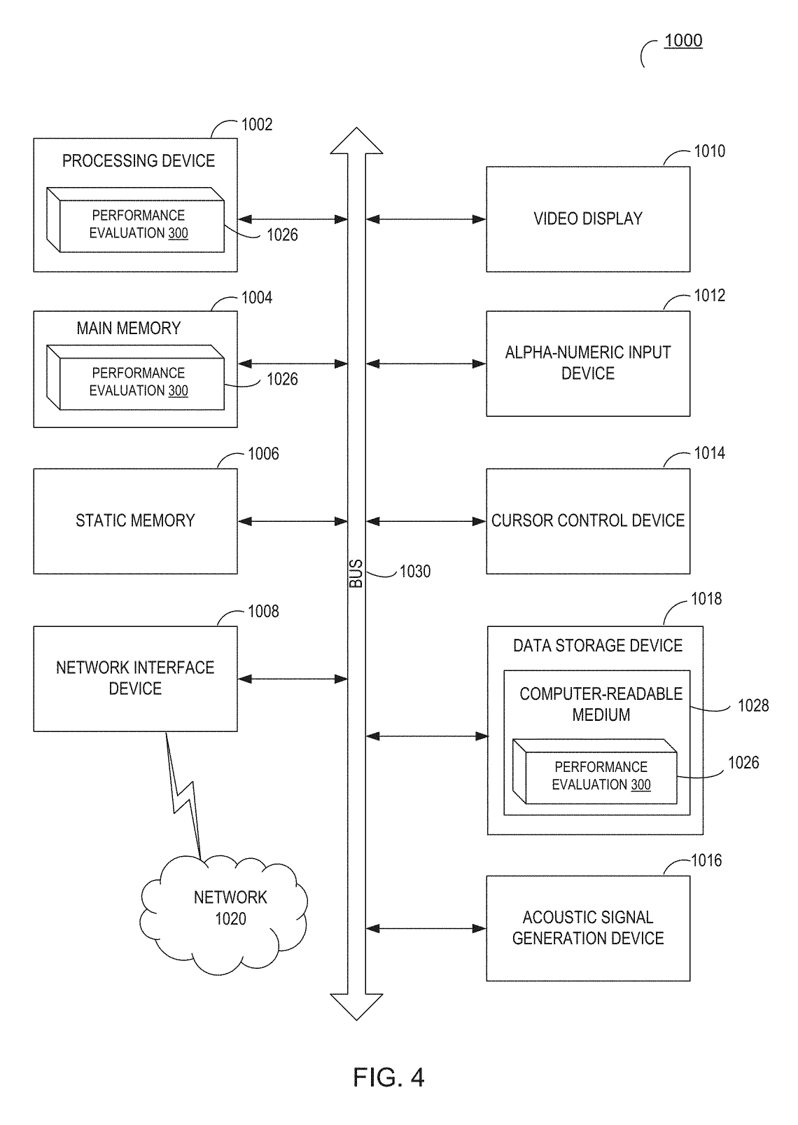

FIG. 4 schematically illustrates a component diagram of an example computer system 1000 which may perform the methods described herein. Example computer system 1000 may be connected to other computer systems in a LAN, an intranet, an extranet, and/or the Internet. Computer system 1000 may operate in the capacity of a server in a client-server network environment. Computer system 1000 may be a personal computer (PC), a set-top box (STB), a server, a network router, switch or bridge, or any device capable of executing a set of instructions (sequential or otherwise) that specify actions to be taken by that device. Further, while only a single example computer system is illustrated, the term “computer” shall also be taken to include any collection of computers that individually or jointly execute a set (or multiple sets) of instructions to perform any one or more of the methods discussed herein.

Example computer system 1000 may comprise a processing device 1002 (also referred to as a processor or CPU), a main memory 1004 (e.g., read-only memory (ROM), flash memory, dynamic random access memory (DRAM) such as synchronous DRAM (SDRAM), etc.), a static memory 1006 (e.g., flash memory, static random access memory (SRAM), etc.), and a secondary memory (e.g., a data storage device 1018), which may communicate with each other via a bus 1030.

Processing device 1002 represents one or more general-purpose processing devices such as a microprocessor, central processing unit, or the like. More particularly, processing device 1002 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 1002 may also be one or more special-purpose processing devices such as an application specific integrated circuit (ASIC), a field programmable gate array (FPGA), a digital signal processor (DSP), network processor, or the like. In accordance with one or more aspects of the present disclosure, processing device 1002 may be configured to execute instructions implementing method 200 of recursive clustering and/or method 300 of document cluster labeling, in accordance with one or more aspects of the present disclosure.

Example computer system 1000 may further comprise a network interface device 1008, which may be communicatively coupled to a network 1020. Example computer system 1000 may further comprise a video display 1010 (e.g., a liquid crystal display (LCD), a touch screen, or a cathode ray tube (CRT)), an alphanumeric input device 1012 (e.g., a keyboard), a cursor control device 1014 (e.g., a mouse), and an acoustic signal generation device 1016 (e.g., a speaker).

Data storage device 1018 may include a computer-readable storage medium (or more specifically a non-transitory computer-readable storage medium) 1028 on which is stored one or more sets of executable instructions 1026. In accordance with one or more aspects of the present disclosure, executable instructions 1026 may comprise executable instructions encoding various functions of method 200 of recursive clustering and/or method 300 of document cluster labeling, in accordance with one or more aspects of the present disclosure.

Executable instructions 1026 may also reside, completely or at least partially, within main memory 1004 and/or within processing device 1002 during execution thereof by example computer system 1000, main memory 1004 and processing device 1002 also constituting computer-readable storage media. Executable instructions 1026 may further be transmitted or received over a network via network interface device 1008.

While computer-readable storage medium 1028 is shown in FIG. 4 as a single medium, the term “computer-readable storage medium” should be taken to include a single medium or multiple media (e.g., a centralized or distributed database, and/or associated caches and servers) that store the one or more sets of VM operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus may be specially constructed for the required purposes, or it may be a general purpose computer system selectively programmed by a computer program stored in the computer system. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages may be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

1. A method of evaluating performance of a person, the method comprising:
processing, by a computer system, a plurality of documents which record communications of a person to identify a task assigned to the person;
identifying a subset of the plurality of documents, wherein the subset of documents is associated with the task;
analyzing the subset of documents to identify a completion status of the task; and
determining a value of a performance metric associated with the person, wherein the value of the performance metric reflects the completion status of the task.

2. The method of claim 1, wherein analyzing the subset of documents further comprises determining a level of sentiments associated with the task, and wherein the performance metric further reflects the level of sentiments.

3. The method of claim 1, wherein analyzing the subset of documents further comprises determining a number of tasks of a given category completed by the person within a specified period of time, and wherein the performance metric further reflects the number of tasks.

4. The method of claim 1, wherein analyzing the subset of documents further comprises determining a rate of responding to communications by the person over a period of time, and wherein the performance metric further reflects the rate of responding to communications.

5. The method of claim 1, further comprising:
determining that a difference between the value of the performance metric associated with the person and an aggregate value of the performance metric associated with an organizational unit associated with the person exceeds a pre-defined threshold; and
generating an alert referencing the value of the performance metric.

6. The method of claim 1, further comprising:
determining that a difference between the value of the performance metric associated with the person and a historic value of the performance metric associated with the person exceeds a pre-defined threshold; and
generating an alert referencing the value of the performance metric.

7. The method of claim 1, wherein analyzing the subset of documents further comprises:
applying, to the subset of documents, a set of production rules yielding the completion status of the task.

8. The method of claim 1, wherein analyzing the subset of documents further comprises:
applying, to the subset of documents, a trainable classifier producing the completion status of the task.

9. The method of claim 1, wherein analyzing the subset of documents further comprises:
applying, to the subset of documents, a neural network producing the completion status of the task.

10. The method of claim 1, wherein the plurality of documents is provided by an electronic mailbox comprising a plurality of electronic mail messages.

11. The method of claim 1, further comprising:
visually representing the value of the performance metric via a graphical user interface.

12. A method of evaluating performance of a person, the method comprising:
processing, by a computer system, a plurality of documents which record communications of a person to identify a task assigned to the person;
identifying a subset of the plurality of documents, wherein the subset of documents is associated with the task;
analyzing the subset of documents to identify a level of sentiments associated with the task; and
determining a value of a performance metric associated with the person, wherein the value of the performance metric reflects the level of sentiments.

13. The method of claim 12, wherein determining the value of the performance metric further comprises:
analyzing the subset of documents to identify a completion status of the task.

14. The method of claim 12, further comprising:
determining that a difference between the value of the performance metric associated with the person and a reference value of the performance metric exceeds a pre-defined threshold; and
generating an alert referencing the value of the performance metric.

15. The method of claim 12, further comprising:
visually representing the value of the performance metric via a graphical user interface.

16. A non-transitory computer-readable storage medium comprising executable instructions that, when executed by a computer system, cause the computer system to:
process a plurality of documents which record communications of a person to identify a task assigned to the person;
apply, to the plurality of documents, a trainable classifier to identify a completion status of the task; and
determine a value of a performance metric associated with the person, wherein the value of the performance metric reflects the completion status of the task.

17. The non-transitory computer-readable storage medium of claim 16, wherein determining the value of the performance metric further comprises:
analyzing the plurality of documents to determine a number of tasks of a given category completed by the person within a specified period of time.

18. The non-transitory computer-readable storage medium of claim 16, wherein determining the value of the performance metric further comprises:
analyzing the plurality of documents to determine a level of sentiments associated with the task.

19. The non-transitory computer-readable storage medium of claim 16, further comprising executable instructions causing the computer system to:
determining that a difference between the value of the performance metric associated with the person and a reference value of the performance metric exceeds a pre-defined threshold; and
generating an alert referencing the value of the performance metric.

20. The non-transitory computer-readable storage medium of claim 16, further comprising executable instructions causing the computer system to:
visually representing the value of the performance metric via a graphical user interface.
